(19) United States
(12) Patent Application Publication
(10) Pub. No.: US 2006/0103696 A1
(43) Pub. Date: May 18, 2006

(54) Inkjet printhead having nozzles capable of simultaneous injection

(76) Inventors: Yong-shik Park, Bundang-gu (KR); Myong-jong Kwon, Suwon-si (KR); Sung-joon Park, Suwon-si (KR)

Correspondence Address: STANZIONE & KIM, LLP, 919 18TH STREET, N.W., SUITE 440, WASHINGTON, DC, 20006, US

(21) Appl. No.: 11/189,839

(22) Filed: Jul. 27, 2005

(30) Foreign Application Priority Data
Nov. 12, 2004 (KR) 2004-92367

(51) Int. Cl. B41J 2/05

(52) U.S. Cl. 347/58

(57) ABSTRACT

An inkjet printhead includes a plurality of heaters connected with an electrode wiring and having a first end connected with a driving electrode, and a chamber pattern forming an ink chamber at each heater. The chamber pattern includes conductive material and forms a common grounding wiring electrically connected with a second end of each heater. Accordingly, the inkjet printhead has nozzles capable of simultaneous injection of ink.

### CROSS-REFERENCE TO RELATED APPLICATIONS

This application claims the benefit under 35 U.S.C. §119 of Korean Patent Application No.2004-92367, filed on Nov. 12, 2004, in the Korean Intellectual Property Office, the disclosure of which is incorporated herein in its entirety by reference.

### BACKGROUND OF THE INVENTION

1. Field of the Invention

The present general inventive concept relates to an inkjet printhead, and more particularly, to an inkjet printhead capable of printing at a high speed by injecting ink simultaneously through a plurality of nozzles.

2. Description of the Related Art

FIG. 1 is a perspective view illustrating a portion of an inkjet printhead of a conventional inkjet printer, and FIG. 2 is a top view illustrating a wiring structure of the inkjet printhead of FIG. 1. Referring to FIGS. 1 and 2, the conventional inkjet printhead has a base plate 10, a chamber pattern 20, and a nozzle plate 30. The base plate 10 has a plurality of heaters 11 disposed thereon and generates heat energy and a wiring 12 electrically connected with the heaters 11. The chamber pattern 20 forms an ink chamber C on top side of each heater 11 of the base plate 10 and an ink passageway communicating with each ink chamber C. The nozzle plate 30 is disposed on the chamber pattern 20 so that a nozzle N can be provided on an upper part of each ink chamber C. With this configuration, an electric current is selectively applied to each heater 11 through an electrode wiring 12a separately connected with electrodes, and then ink from the ink chamber C is injected through the nozzle N by bubbles generated due to heat from the heater 11.

FIG. 3 is a view simplifying an electrical structure of the conventional inkjet printhead. As shown in FIG. 3, the electric current, applied from the separate electrode (not shown) to the respective electrode wiring 12a by a controller (not shown), heats the inside of the ink chamber C by passing through the heater 11. Subsequently the electric current flows to a common ground wiring 13 by passing through a ground wiring 12b. Here, the resistances of the electrode and ground wirings 12a and 12b and the common ground wiring 13 are directly proportional to the length of their respective wires and inversely proportional to the width of their respective wires. Accordingly, the resistances of the ground wiring 12b and the common ground wiring 13 of the heater No.1 are higher than those of the heater No.8. On the other hand, the amount of heat generated by the heater No.1 is lower than that of the heater No.8, such that the amount of bubbles generated in each ink chamber C is different. Thus, in the inkjet printhead provided with the conventional wiring structure, each of the nozzles N injects a different amount of ink due to the difference in the amounts of heat generated by the heaters 11 when the nozzles N inject ink simultaneously.

As shown in FIG. 3, in the wiring structure of the conventional printhead, sixteen heaters (for example, heaters No.1 to No.16) employ a single common ground wiring 13, and are controlled to drive one heater at a time because the conventional printhead generates heat due to resistance of the ground wiring 12b and common ground wiring 13. Consequently, it is difficult for the conventional inkjet printhead to inject ink through each nozzle N simultaneously.

The disadvantage described above will be described in detail below. The wiring in the inkjet printhead is in the form of a thin film due to properties of the conventional wiring structure, and the thickness of the wiring is usually 1 μm or less. When the electric current passes through the wires, the wires generate heat due to their internal resistance. To overcome the above disadvantage, only one of the adjacent heaters, for example the heater No. 8 among the heaters No. 1 to No. 16, is operated at one time. Accordingly, the conventional printhead is incapable of efficiently injecting ink through each nozzle N simultaneously. Further, even if the inkjet printhead is capable of injecting through each nozzle N simultaneously, the resistance in the wires generates heat, thereby damaging the inkjet printhead.

Furthermore, a printing speed of the conventional printhead is slow because the conventional printhead has to print a same line repeatedly.

Table 1 shows an experimental result of an operation efficiency of the conventional printhead having the wiring structure shown in FIG. 3.

TABLE 1
ELECTRIC POWER OF HEATERS AND RESISTANCE OF COMMON
GROUND WIRING ACCORDING TO OPERATION CONDITION

| | WHEN ONE HEATER OPERATES | | WHEN ALL HEATERS OPERATE | |
|---|---|---|---|---|
| | | RESISTANCE OF | | RESISTANCE OF |
| HEATER | HEATER | COMMON GROUND | HEATER | COMMON GROUND |
| NUMBER | POWER (W) | WIRING(Ω) | POWER (W) | WIRING(Ω) |
| #1 | 2.66 | 2.04 | 1.26 | 25.7 |
| #16 | 2.68 | 1.84 | 1.31 | 24.2 |
| #17 | 2.65 | 2.11 | 1.16 | 28.7 |
| #32 | 2.67 | 1.94 | 1.20 | 27.2 |
| #33 | 2.65 | 2.11 | 1.12 | 30.2 |
| #48 | 2.66 | 2.01 | 1.14 | 29.3 |

As shown in Table 1, when one heater is operated, the electric power of each heater is as high as 2.65˜2.68 W and has little variance, but when all the heaters are operated the electric power of each heater becomes as low as 1.12˜1.31 W, which is 45% of the electric power when one heater is operated. Because each heater of the conventional inkjet printhead produces a different amount of electric power when all the heaters operate, the inkjet printhead cannot print in good quality when injecting the ink simultaneously through each nozzle N. Also, as shown in Table 1, when all of the heaters are operated, the resistance of the common ground wiring 13 increases up to about ten times as compared with the case when a single heater is operated. Thus, the common ground wiring 13 generates a large amount of heat when injecting ink simultaneously through each nozzle N.

### SUMMARY OF THE INVENTION

Accordingly, the present general inventive concept provides an inkjet printhead having nozzles capable of simultaneous injection by improving a wiring structure of the inkjet printhead.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an inkjet printhead comprising a plurality of heaters connected with an electrode wiring and having a first end connected with a driving electrode, and a chamber pattern forming an ink chamber at each heater. The chamber pattern comprises a conductive material and forms a common ground wiring electrically connected with a second end of each heater.

The inkjet printhead may further comprise a grounding connecting part extending from the second end of each heater and an insulation protecting layer interposed between the grounding connecting part and the chamber pattern, wherein the insulation protecting layer comprises via-holes and the chamber pattern is electrically connected with the grounding connecting part by way of the via-holes.

At least one part of inner walls of the ink chamber can be formed with an insulation layer.

The chamber pattern can be plated with the conductive material.

The chamber pattern can be plated with copper and/or nickel.

The thickness of the chamber pattern can be 5 μm or more.

The foregoing and/or other aspects and advantages of the present general inventive concept are also achieved by providing an inkjet printhead, comprising a plurality of heaters to generate heat, and a conductive chamber layer forming an ink chamber at a surface of each heater and providing a common ground to each heater.

The inkjet printhead may further comprise ground connecting wiring to electrically connect the plurality of heaters to the conductive chamber layer.

The inkjet printhead may further comprise an insulation film surrounding the ground connecting wiring and via holes provided in the insulation film to allow the ground connecting wiring to contact the conductive chamber layer.

Resistances through the conductive chamber layer from each of the heaters to the common ground may be substantially equal.

Power produced by each heater may be substantially equal with respect to each other when all of the heaters produce power simultaneously.

The inkjet printhead may further comprise a plurality of nozzles disposed above the conductive chamber layer to inject ink therefrom when the plurality of heaters generate heat.

When each of the plurality of nozzles ejects ink simultaneously, each of the plurality of heaters may generate a substantially equal amount of heat.

An amount of heat generated by one of the plurality of heaters when only the one of the plurality of heaters operates may be substantially equal to the amount of heat generated by the one of the plurality of heaters when all of the plurality of heaters operate.

A thickness of the conductive chamber layer may be substantially 10 μm to 20 μm.

The foregoing and/or other aspects and advantages of the present general inventive concept are also achieved by providing an inkjet printer, comprising an inkjet printhead comprising a plurality of nozzles disposed along a width of the inkjet printhead to eject ink therefrom, a conductive chamber pattern to form an ink chamber at each of the plurality of nozzles, and a heater disposed at each ink chamber to operate individually or simultaneously with respect to each other to heat ink stored in the respective ink chamber, each heater being electrically connected to the conductive chamber pattern to be grounded therethrough.

The width of the inkjet printhead may be substantially equal to a width of a printing medium, and when the heaters operate simultaneously, the plurality of nozzles may eject ink simultaneously along the width of the printing medium.

The inkjet printer may further comprise a ground terminal electrically connected to the conductive chamber pattern to ground the plurality of heaters.

Resistances through the conductive chamber pattern from each of the heaters to a ground may be substantially equal.

Power produced by each heater may be substantially equal with respect to each other when all of the heaters operate simultaneously.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic perspective view of a conventional inkjet printhead;

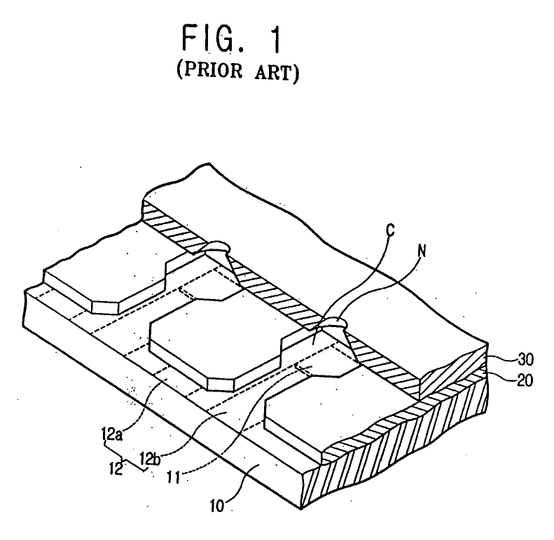

FIG. 2 is a top view of a wiring structure of the conventional inkjet printhead of FIG. 1;

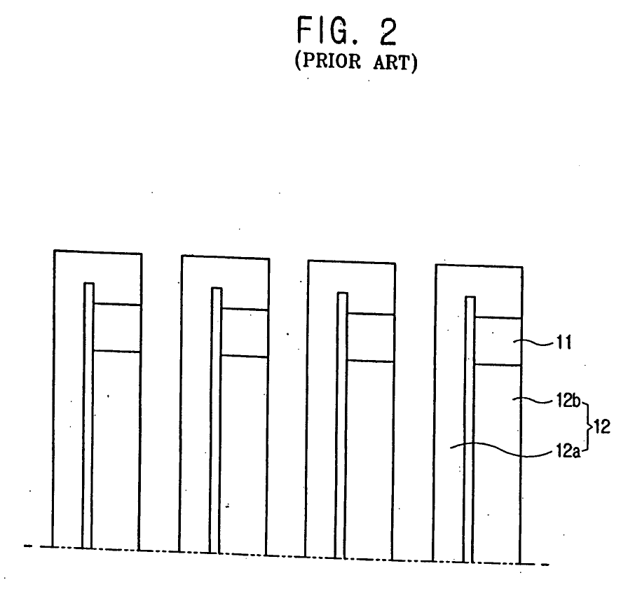

FIG. 3 is a view simplifying a total wiring structure of the conventional inkjet printhead of FIG. 1;

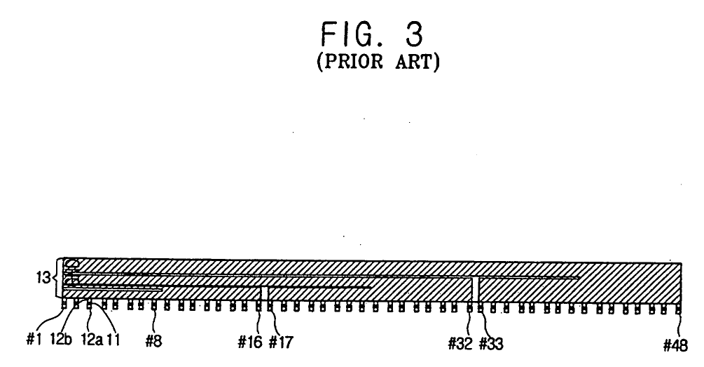

FIG. 4 is a schematic perspective view illustrating an inkjet printhead according to an embodiment of the present general inventive concept;

FIG. 5 is a top view illustrating the inkjet printhead of FIG. 4;

FIG. 6 is an enlarged view illustrating a section of the inkjet printhead of FIG. 5 taken along a line VI-VI; and

FIG. 7 is a view illustrating a wiring structure of the inkjet printhead head of FIG. 4.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The embodiments are described below in order to explain the present general inventive concept while referring to the figures.

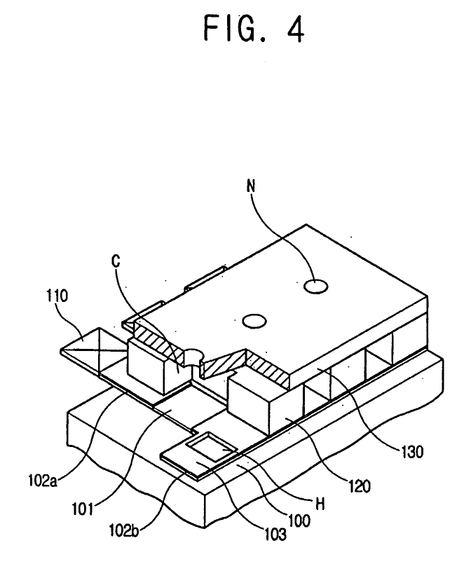

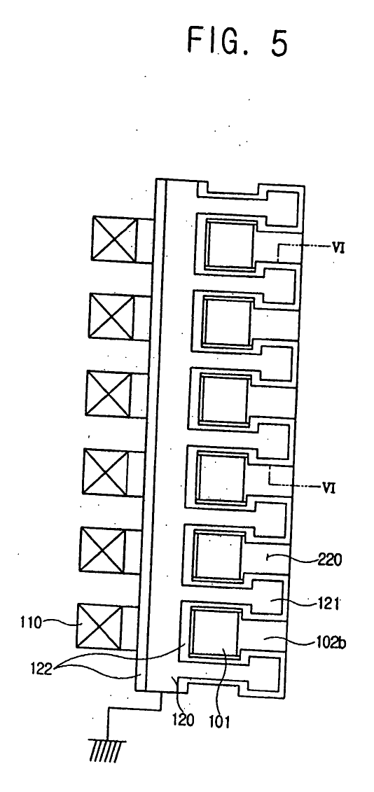

FIGS. 4 and 5 illustrate an inkjet printhead according to an embodiment of the present general inventive concept. Referring to FIGS. 4 and 5, the inkjet printhead comprises a base plate 100, a chamber pattern 120, and a nozzle plate 130. The base plate 100 includes a plurality of heaters 101 disposed thereon to generate heat energy and a ground connecting wiring 102b which is electrically connected with the heaters 101 and coated with a silicon oxide film 103 functioning as an insulation protecting layer. The chamber pattern 120 forms an ink chamber C at a top side of each heater 101 and an ink passageway 220 communicating with each ink chamber C. The nozzle plate 130 is disposed on the chamber pattern 120 such that a nozzle N can be equipped at an upper portion of each ink chamber C.

A first end of each heater 101 is electrically connected with an electrode pad 110 by an electrode wiring 102a, which is joined with the electrode pad 110 by a respective driving electrode (not shown). The ground connecting wiring 102b extends from a second end of each heater 101 to join with a common ground wiring. The electrode wiring 102a and the ground connecting wiring 102b may be made of a thin aluminum film. The ground connecting wiring 102b extends from each heater 101 and is electrically connected to a first side of the chamber pattern 120.

The chamber pattern 120 may be made of a conductive material, such as copper, nickel, etc. The chamber pattern 120 may alternatively be plated with copper and/or nickel. As illustrated in FIG. 5, the chamber pattern 120 forms separating walls between immediately adjacent heaters 101, forms chamber walls by enclosing the first end of each heater 101, and forms the ink passageway 220 by leaving the second end of each heater 101 open. In addition, a photoresist film 122 is formed as an insulation film along the walls of the chamber pattern 120 to prevent the chamber pattern 120 from corrosion due to direct contact with ink and to prevent an electric current from flowing from the heater 101 to the chamber pattern 120 via the ink. Here, the photoresist film 122 can be formed after the chamber pattern 120 is formed. For example, a photoresist is coated on the chamber pattern 120, and then the photoresist is exposed and etched.

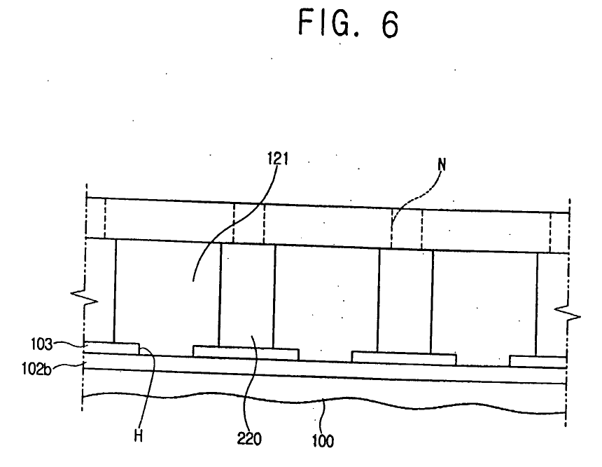

FIG. 6 illustrates the inkjet printhead of FIG. 5 taken along an imaginary line VI-VI. Referring to FIG. 6, a first side 121 of the chamber pattern 120 forming the ink passageway 220 is electrically connected with the ground connecting wiring 102b by way of via-holes H provided at intervals in the silicon oxide film 103 to allow the ground connecting wiring 102b to contact a lower part of the chamber pattern 120.

With this configuration, an electric current, which passes through the heater 101, flows to the chamber pattern 120 through the via-holes H. Here, by providing a ground terminal (see FIG. 5) on a first end of the chamber pattern 120, the chamber pattern 120 acts as the common ground wiring. Since the chamber pattern 120 acts as the common ground wiring, the resistance of the common ground wiring is low. The thickness of the chamber pattern 120 can be about 10 μm to 20 μm. Also considering generated heat due to resistance, the thickness of the chamber can be 5 μm or more.

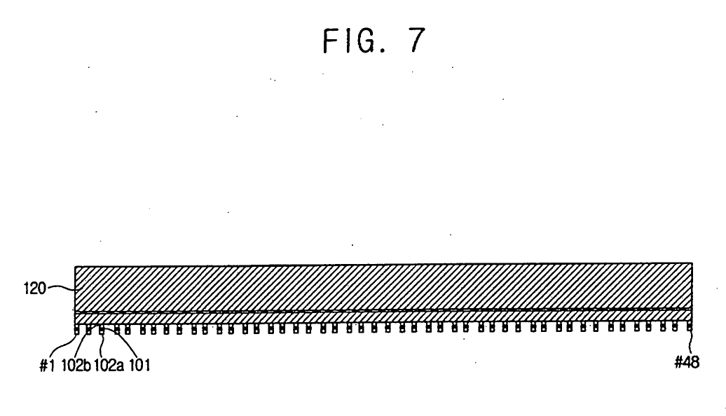

FIG. 7 illustrates a wiring structure of the inkjet printhead head of FIG. 4. Referring to FIG. 7, the electric current is applied from individual driving electrodes (not shown) to the respective electrode wiring 102a by a controller (not shown) and heats inside portions of the ink chambers C while passing through the heaters 101. Subsequently, the electric current flows to the chamber pattern 120 acting as the common ground wiring through the ground connecting wirings 102b. Here, the resistances of the ground connecting wirings 102b and the chamber pattern 120 from a heater No.1 to a heater No.48 are substantially equal, and the resistance of the chamber pattern 120 as the common ground wiring is much lower than that of a thin film type common ground wiring. Consequently, there is little difference in power produced between when one heater operates and when all of the heaters operate, and the heat generated due to the resistance is remarkably reduced.

Table 2 illustrates an experimental result of an operation efficiency of the printhead having the wiring structure in FIG. 7.

TABLE 2
ELECTRIC POWER OF HEATERS AND RESISTANCE OF COMMON
GROUND WIRING ACCORDING TO OPERATION CONDITION

| | WHEN ONE HEATER OPERATES | | WHEN ALL HEATERS OPERATE | |
|---|---|---|---|---|
| | | RESISTANCE OF | | RESISTANCE OF |
| HEATER | HEATER | COMMON GROUND | HEATER | COMMON GROUND |
| NUMBER | POWER (W) | WIRING (Ω) | POWER (W) | WIRING (Ω) |
| #1 | 2.86 | 0.110 | 2.86 | 0.146 |
| #16 | 2.87 | 0.091 | 2.80 | 0.710 |
| #17 | 2.86 | 0.090 | 2.79 | 0.736 |
| #32 | 2.86 | 0.107 | 2.75 | 1.12 |
| #33 | 2.86 | 0.106 | 2.75 | 1.13 |
| #48 | 2.86 | 0.168 | 2.73 | 1.30 |

As illustrated in Table 2, there is little difference in the power produced from the heaters 101 between when only one of the heaters 101 operates and when all the heaters 101 operate (i.e. heater numbers 1-48). (Table 2 illustrates that a maximum difference is from 2.86 W to 2.73 W in the heater No. 48, that is, a 4.5% difference.) Therefore there will be little difference in the power produced from the heaters 101 between when only one nozzle N injects ink and when all the nozzles N inject ink simultaneously.

Furthermore, even though all of the heaters 101 operate, the resistance of the common ground wiring 120 is relatively low, such that the inkjet printhead does not generate much heat. Comparing the resistances of the common ground wirings between Table 1 and Table 2, the common ground wiring 120 according to the embodiment of present general inventive concept has lower resistance when all of the heaters operate than does the conventional common ground wiring when only one heater operates.

An inkjet printhead according to the present general inventive concept having nozzles capable of a simultaneous injection of ink can be employed in a line-width printhead, of which the width is as same as that of print paper. The line-width printhead can be fixed while it ejects ink from its nozzle, and the print paper passes under the line-width printhead, thereby improving a print speed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printhead comprising:
a plurality of heaters connected with an electrode wiring, each heater having a first end connected with an electrode pad; and
a chamber pattern forming an ink chamber at each heater, the chamber pattern comprising conductive material and forming a common ground wiring electrically connected with a second end of each heater.

2. The inkjet printhead of claim 1, further comprising:
a grounding connecting part extending from the second end of each heater; and
an insulation protecting layer interposed between the grounding connecting part and the chamber pattern, wherein the insulation protecting layer comprises via-holes and the chamber pattern is electrically connected with the grounding connecting part by way of the via-holes.

3. The inkjet printhead of claim 1, wherein at least one part of inner walls of the ink chamber is formed with an insulation layer.

4. The inkjet printhead of claim 1, wherein the chamber pattern is plated with the conductive material.

5. The inkjet printhead of claim 4, wherein the chamber pattern is plated with copper and/or nickel.

6. The inkjet printhead of claim 2, wherein the chamber pattern is plated with the conductive material.

7. The inkjet printhead of claim 6, wherein the chamber pattern is plated with copper and/or nickel.

8. The inkjet printhead of claim 3, wherein the chamber pattern is plated with the conductive material.

9. The inkjet printhead of claim 8, wherein the chamber pattern is plated with copper and/or nickel.

10. The inkjet printhead of claim 1, wherein the thickness of the chamber pattern is 5 μm or more.

11. The inkjet printhead of claim 2, wherein the thickness of the chamber pattern is 5 μm or more.

12. The inkjet printhead of claim 3, wherein the thickness of the chamber pattern is 5 μm or more.

13. An inkjet printhead, comprising:
a plurality of heaters to generate heat; and
a conductive chamber layer forming an ink chamber at a surface of each heater and providing a common ground to each heater.

14. The inkjet printhead of claim 13, further comprising:
ground connecting wiring to electrically connect the plurality of heaters to the conductive chamber layer.

15. The inkjet printhead of claim 14, further comprising:
an insulation film surrounding the ground connecting wiring; and
via holes provided in the insulation film to allow the ground connecting wiring to contact the conductive chamber layer.

16. The inkjet printhead of claim 13, wherein resistances through the conductive chamber layer from each of the heaters to the common ground are substantially equal.

17. The inkjet printhead of claim 13, wherein power produced by each heater is substantially equal with respect to each other when all of the heaters produce power simultaneously.

18. The inkjet printhead of claim 13, further comprising:
a plurality of nozzles disposed above the conductive chamber layer to inject ink therefrom when the plurality of heaters generate heat.

19. The inkjet printhead of claim 18, wherein the when each of the plurality of nozzles ejects ink simultaneously, each of the plurality of heaters generates a substantially equal amount of heat.

20. The inkjet printhead of claim 13, wherein an amount of heat generated by one of the plurality of heaters when only the one of the plurality of heaters operates is substantially equal to the amount of heat generated by the one of the plurality of heaters when all of the plurality of heaters operate.

21. The inkjet printhead of claim 13, wherein a thickness of the conductive chamber layer is substantially 10 μm to 20 μm.

22. An inkjet printer, comprising:
an inkjet printhead comprising:
a plurality of nozzles disposed along a width of the inkjet printhead to eject ink therefrom,
a conductive chamber pattern to form an ink chamber at each of the plurality of nozzles, and
a heater disposed at each ink chamber to operate individually or simultaneously with respect to each other to heat ink stored in the respective ink chamber, each heater being electrically connected to the conductive chamber pattern to be grounded therethrough.

23. The inkjet printer of claim 22, wherein the width of the inkjet printhead is substantially equal to a width of a printing medium, and when the heaters operate simultaneously, the plurality of nozzles eject ink simultaneously along the width of the printing medium.

24. The inkjet printer of claim 22, further comprising:
a ground terminal electrically connected to the conductive chamber pattern to ground the plurality of heaters.

25. The inkjet printer of claim 22, wherein resistances through the conductive chamber pattern from each of the heaters to a ground are substantially equal.

26. The inkjet printer of claim 22, wherein power produced by each heater is substantially equal with respect to each other when all of the heaters operate simultaneously.
